(19) United States
(12) Patent Application Publication
(10) Pub. No.: US 2015/0296936 A1
(43) Pub. Date: Oct. 22, 2015

(54) OPTICAL VARIABLE EFFECTS AS SECURITY FEATURE FOR EMBOSSED METAL COINS

(71) Applicants: SICPA HOLDING SA, Prilly (CH); CHINA BANKNOTE SICPA SECURITY INK CO., LTD., Beijing (CN)

(72) Inventors: Raynald DEMANGE, Montagny-pres-Yverdon (CH); Pierre DEGOTT, Crissier (CH); Véronique KALTENRIEDER, Palézieux-Village (CH); Mathieu SCHMID, Lausanne (CH); Xiang LI, Beijing (CN)

(73) Assignees: SICPA HOLDING SA, Prilly (CH); CHINA BANKNOTE SICPA SECURITY INK CO., LTD., Beijing (CN)

(21) Appl. No.: 14/647,944

(22) PCT Filed: Nov. 29, 2012
(86) PCT No.: PCT/CN2012/085540

§ 371 Date: May 28, 2015

(51) Int. Cl. A44C 21/00; B05D 3/06; B05D 3/02; H01F 41/32; B05D 7/00; H01F 1/04; H01F 1/09; B05D 1/28; B05D 5/06

(52) U.S. Cl. CPC A44C 21/00; B05D 1/28; B05D 3/067; B05D 3/0254; B05D 5/065; B05D 7/56; H01F 1/04; H01F 1/09; H01F 41/32

(57) ABSTRACT

The present invention relates to the field of the protection against counterfeiting or illegal reproduction of embossed metal coins. In particular, the present invention provides embossed metal coins comprising a coating layer made of an optically variable composition comprising a plurality of optically variable pigment particles.

### FIELD OF THE INVENTION

The present invention relates to the field of the protection against counterfeiting or illegal reproduction of embossed metal coins.

### BACKGROUND OF THE INVENTION

With the constantly improving quality of color photocopies and printings and in an attempt to protect security documents such as banknotes, value documents or cards, transportation tickets or cards, tax banderols, and product labels against counterfeiting, falsifying or illegal reproduction, it has been the conventional practice to incorporate various security means in these documents. Typical example of security means include security threads, windows, fibers, planchettes, foils, decals, holograms, watermarks, security inks comprising optically variable pigment particles, multilayer thin-film interference pigments, interference-coated particles, thermochromic pigments, photochromic pigments, luminescent, infrared-absorbing, ultraviolet-absorbing or magnetic compounds.

Counterfeiting of embossed metal coins (e.g. piece of metal authorized by a government for use as money) in circulation has been made by criminals for a long time. However, very few developments concerning their protection against counterfeiting or illegal reproduction have been done.

For example, a method for protecting embossed metal coins from forgeries consists of using bi-metallic coins made of two different metals exhibiting different colors, thereby rendering more difficult the counterfeiting or illegal reproduction at low cost.

Alternatively and in a similar way of what can be used to protect banknotes against counterfeiting, it has been recently proposed to incorporate a taggant in metal coins as a machine-readable authentication tool preventing coin counterfeiting (Authentication News, March 2012, Vol 18, No 3, p. 12).

There remains a need for a method to protect and increase the resistance to counterfeiting and illegal reproduction of metal coins.

### SUMMARY

The present invention provides embossed metal coins comprising a coating layer made of an optically variable composition comprising a plurality of optically variable pigment particles.

In a second aspect, the invention provides a process for preparing the embossed metal coins described herein, said process comprising the steps of a) applying by pad printing or screen printing the optically variable composition described herein on an embossed metal coin, and b) hardening the optically variable composition so as to form a coating layer on the embossed metal coin.

In a third aspect, the invention provides a use of the coating layer described herein for the protection of an embossed metal coin against fraud or illegal reproduction.

In a fourth aspect, the invention provides method for protecting an embossed metal coin against fraud or illegal reproduction comprising the steps of a) applying by pad printing or screen printing the optically variable composition described herein on the embossed metal coin, and b) hardening the optically variable composition so as to form a coating layer on the embossed metal coin.

### DETAILED DESCRIPTION

The following definitions are to be used to interpret the meaning of the terms discussed in the description and recited in the claims.

As used herein, the article “a” indicates one as well as more than one and does not necessarily limit its referent noun to the singular.

As used herein, the term “about” means that the amount or value in question may be the value designated or some other value about the same. The phrase is intended to convey that similar values within a range of ±5% of the indicated value promote equivalent results or effects according to the invention.

As used herein, the term “and/or” or “or/and” means that either all or only one of the elements of said group may be present. For example, “A and/or B” shall mean “only A, or only B, or both A and B”.

As used herein, the term “at least” is meant to define one or more than one, for example one or two or three.

As used herein, the term “comprise” or variations such as “comprises” or “comprising” will be understood to imply the inclusion of a stated feature, integer, step or component or group of features, integers, steps or components but does not preclude the presence or addition of one or more others features, integers, steps or components.

The term “composition” refers to any composition which is capable of forming a coating on a solid substrate and which can be applied preferentially but not exclusively by a printing method.

As used herein, the term “pigment” is to be understood according to the definition given in DIN 55943: 1993-11 and DIN EN 971-1: 1996-09. Pigments are materials in powder or flake form which are—contrary to dyes—not soluble in the surrounding medium.

The present invention provides embossed metal coins comprising a coating layer made of an optically variable composition comprising a plurality of optically variable pigment particles.

In the currencies of various countries, coins consist of pieces of metal authorized by a government and are used as means of payment. Such coins are manufactured from at least one disk-shaped blank or base element of metal or a metal alloy. Metal coins comprise one or more embossments on the front side and/or on the reverse side of the metal coins, by means of which a motif, such as for example a numeral indicating the value of the metal coin, a symbol, a picture or various decorative elements, is applied to the front and/or reverse side of the metal coin. The principle of embossing coins is known in the art and usually consists of a process wherein a metal coin in the form of a disk-shaped blank or base element is typically placed between an upper and a lower die, which respectively bear the negative of the motif to be embossed, said process is further followed by embossment of the metal coin. The embossed metal coins described herein may further comprise one or more marker substances and/or taggants.

The coating layers described herein are made of optically variable compositions comprising a plurality of optically variable pigment particles. Optically variable pigment particles are known in the field of security printing and are used in coating layers so as to provide an optically variable element on a security document. Optically variable elements (also referred in the art as goniochromatic elements) exhibit a viewing-angle or incidence-angle dependent color, and are used to protect banknotes and other security documents against counterfeiting and/or illegal reproduction by commonly available color scanning, printing and copying office equipment. For example, the coating layer made of an optically variable composition comprising a plurality of optically variable pigment particles exhibits a colorshift upon variation of the viewing angle (e.g. from a viewing angle of about 22.5° with respect to the plane of the layer to a viewing angle of about 90° with respect to the plane of the layer) from a color impression CI1 (e.g. magenta) to a color impression CI2 (green).

The colorshifting property of the coating layer is considered to be an easy-to-detect overt security feature for the public. Advantageously, any one is able to easily detect, recognize and/or discriminate the embossed metal coins according to the present invention from their possible counterfeits with the unaided human senses, e.g. such features may be visible and/or detectable while still being difficult to produce and/or to copy. Moreover, the colorshifting property of the coating layer may be used as an authentication tool for the recognition of embossed metal coins by a machine. In addition to the size, weight and/or metal composition, a currency detector or validator, such as for example self checkout machines, gaming machines, slot machines, transportation machine and vending machines, may advantageously assess whether the embossed metal coin is genuine or counterfeit due to the presence of the optically variable composition.

The optically variable compositions described herein comprise plurality of optically variable pigment particles. Preferably, the plurality of optically variable pigment particles is comprised in the optically variable compositions described herein in an amount between about 5 and about 40 wt-% and more preferably in an amount between about 10 and about 40 wt-%, the weight percents being based on the total weight of the optically variable composition.

According to one embodiment of the present invention, at least a part of the plurality of optically variable pigment particles comprised in the optically variable compositions described herein preferably consists of thin film interference pigments, interference coated pigments, cholesteric liquid crystal pigments or mixtures thereof.

Suitable thin-film interference pigments exhibiting optically variable characteristics are known to those skilled in the art and disclosed in U.S. Pat. No. 4,705,300; U.S. Pat. No. 4,705,356; U.S. Pat. No. 4,721,271; U.S. Pat. No. 5,084,351; U.S. Pat. No. 5,214,530; U.S. Pat. No. 5,281,480; U.S. Pat. No. 5,383,995; U.S. Pat. No. 5,569,535, U.S. Pat. No. 5,571,624 and in the thereto related documents. When at least a part of the plurality of optically variable pigment particles consists of thin film interference pigments, it is preferred that the thin film interference pigments comprise a Fabry-Perot reflector/dielectric/absorber multilayer structure and more preferably a Fabry-Perot absorber/dielectric/reflector/dielectric/absorber multilayer structure, wherein the absorber layers are partially transmitting and partially reflecting, the dielectric layers are transmitting and the reflective layer is reflecting the incoming light. Preferably, the reflector layer is selected from the group consisting of metals, metal alloys and combinations thereof, preferably selected from the group consisting of reflective metals, reflective metal alloys and combinations thereof and more preferably selected from the group consisting of aluminum (Al), chromium (Cr), nickel (Ni), and mixtures thereof and still more preferably aluminum (Al). Preferably, the dielectric layers are independently selected from the group consisting of magnesium fluoride (MgF₂), silicium dioxide (SiO₂) and mixtures thereof and more preferably magnesium fluoride (MgF₂). Preferably, the absorber layers are independently selected from the group consisting of chromium (Cr), nickel (Ni), metallic alloys and mixtures thereof and more preferably chromium (Cr). When at least a part of the plurality of optically variable pigment particles consists of thin film interference pigments, it is particularly preferred that the thin film interference pigments comprise a Fabry-Perot absorber/dielectric/reflector/dielectric/absorber multilayer structure consisting of a Cr/MgF₂/Al/MgF₂/Cr multilayer structure.

Liquid crystals in the cholesteric phase exhibit a molecular order in the form of a helical superstructure perpendicular to the longitudinal axes of its molecules. The helical superstructure is at the origin of a periodic refractive index modulation throughout the liquid crystal material, which in turn results in a selective transmission/reflection of determined wavelengths of light (interference filter effect). Cholesteric liquid crystal polymers can be obtained by subjecting one or more crosslinkable substances (nematic compounds) with a chiral phase to alignment and orientation. The particular situation of the helical molecular arrangement leads to cholesteric liquid crystal materials exhibiting the property of reflecting a circularly polarized light component within a determined wavelength range. The pitch (i.e. the distance over which a full rotation of 360° of the helical arrangement is completed) can be tuned in particular by varying selectable factors including the temperature and solvents concentration, by changing the nature of the chiral component(s) and the ratio of nematic and chiral compounds. Crosslinking under the influence of UV radiation freezes the pitch in a predetermined state by fixing the desired helical form so that the color of the resulting cholesteric liquid crystal materials is no longer depending on external factors such as the temperature. Cholesteric liquid crystal materials may then be shaped to cholesteric liquid crystal pigments by subsequently comminuting the polymer to the desired particle size. Examples of films and pigments made from cholesteric liquid crystal materials and their preparation are disclosed in U.S. Pat. No. 5,211,877; U.S. Pat. No. 5,362,315 and U.S. Pat. No. 6,423,246 and in EP-A 1 213 338; EP-A 1 046 692 and EP-A 0 601 483, the respective disclosure of which is incorporated by reference herein.

Suitable interference coated pigments include without limitation structures consisting of a substrate selected from the group consisting of metallic cores such as titanium, silver, aluminum, copper, chromium, iron, germanium, molybdenum, tantalum or nickel coated with one or more layers made of metal oxides as well as structure consisting of a core made of synthetic or natural micas, other layered silicates (e.g. talc, kaolin and sericite), glasses (e.g. borosilicates), silicium dioxides (SiO₂), aluminum oxides (Al₂O₃), titanium oxides (TiO₂), graphites and mixtures thereof coated with one or more layers made of metal oxides (e.g. titanium oxides, zirconium oxides, tin oxides, chromium oxides, nickel oxides, copper oxides and iron oxides), the structures described hereabove have been described for example in Chem. Rev. 99 (1999), G. Pfaff and P. Reynders, pages 1963-1981 and WO 2008/083894. Typical examples of these interference coated pigments include without limitation silicium oxide cores coated with one or more layers made of titanium oxide, tin oxide and/or iron oxide; natural or synthetic mica cores coated with one or more layers made of titanium oxide, silicium oxide and/or iron oxide, in particular mica cores coated with alternate layers made of silicium oxide and titanium oxide; borosilicate cores coated with one or more layers made of titanium oxide, silicium oxide and/or tin oxide; and titanium oxide cores coated with one or more layers made of iron oxide, iron oxide-hydroxide, chromium oxide, copper oxide, cerium oxide, aluminum oxide, silicium oxide, bismuth vanadate, nickel titanate, cobalt titanate and/or antimony-doped, fluorine-doped or indium-doped tin oxide; aluminum oxide cores coated with one or more layers made of titanium oxide and/or iron oxide.

According to one embodiment of the present invention, at least a part of the plurality of optically variable pigment particles comprised in the optically variable compositions described herein consists of magnetic or magnetizable optically variable pigment particles. Preferably, the magnetic or magnetizable optically variable pigment particles described herein are selected from the group consisting of magnetic thin-film interference pigments, magnetic cholesteric liquid crystal pigments, interference coated pigments comprising a magnetic material and mixtures thereof.

According to one embodiment, the magnetic or magnetizable optically variable pigment particles described herein consist of magnetic thin film interference pigments. Due to their magnetic characteristics being machine readable, compositions comprising magnetic or magnetizable optically variable pigment particles may be detected for example with the use of specific magnetic detectors. Therefore, compositions comprising magnetic or magnetizable optically variable pigment particles may be used as an authentication tool for metal embossed coins. Suitable magnetic thin film interference pigments exhibiting optically variable characteristics are known to those skilled in the art and disclosed in U.S. Pat. No. 4,838,648; WO 02/073250; EP-A 686 675; WO 03/00801; U.S. Pat. No. 6,838,166; WO 2007/131833 and in the thereto related documents. Due to their magnetic characteristics being machine readable, compositions comprising magnetic thin film interference pigments may be detected for example with the use of specific magnetic detectors. Therefore, compositions comprising magnetic thin film interference pigments may be used as an authentication tool for embossed metal coins.

When at least a part of the plurality of optically variable pigment particles consists of magnetic thin film interference pigments, it is preferred that the magnetic thin film interference pigments consist of five-layer Fabry-Perot multilayer structures, six-layer Fabry-Perot multilayer structures, seven-layer Fabry-Perot multilayer structures or any combination thereof. Preferred five-layer Fabry-Perot multilayer structures consist of absorber/dielectric/reflector/dielectric/absorber multilayer structures wherein the reflector and/or the absorber is also a magnetic layer. Preferred six-layer Fabry-Perot multilayer structures consist of absorber/dielectric/reflector/magnetic/dielectric/absorber multilayer structures. Preferred seven-layer Fabry Perot multilayer structures consist of absorber/dielectric/reflector/magnetic/reflector/dielectric/absorber multilayer structures such as disclosed in U.S. Pat. No. 4,838,648; and more preferably a seven-layer Fabry-Perot absorber/dielectric/reflector/magnetic/reflector/dielectric/absorber multilayer structure. Preferably, the reflector layers described herein are selected from the group consisting of metals, metal alloys and combinations thereof, preferably selected from the group consisting of reflective metals, reflective metal alloys and combinations thereof and more preferably from the group consisting of aluminum (Al), chromium (Cr), nickel (Ni), and mixtures thereof and still more preferably aluminum (Al). Preferably, the dielectric layers are independently selected from the group consisting of magnesium fluoride (MgF₂), silicium dioxide (SiO₂) and mixtures thereof and more preferably magnesium fluoride (MgF₂). Preferably, the absorber layers are independently selected from the group consisting of chromium (Cr), nickel (Ni), metallic alloys and mixtures thereof and more preferably chromium (Cr). Preferably, the magnetic layer is preferably selected from the group consisting of nickel (Ni), iron (Fe) and cobalt (Co) and mixtures and/or alloys thereof. When at least a part of the plurality of optically variable pigment particles comprises magnetic thin film interference pigments consisting of a six-layer Fabry-Perot absorber/dielectric/reflector/magnetic/dielectric/absorber multilayer structure, said multilayer structure preferably consists of Cr/MgF₂/Al/magnetic/MgF₂/Cr multilayer structures. When at least a part of the plurality of optically variable pigment particles comprises magnetic thin film interference pigments consisting of a seven-layer Fabry-Perot absorber/dielectric/reflector/magnetic/reflector/dielectric/absorber multilayer structure, said multilayer structure preferably consists of Cr/MgF₂/Al/Ni/Al/MgF₂/Cr multilayer structures.

Thin film interference pigments and magnetic thin film interference pigments described herein are typically manufactured by vacuum deposition of the different required layers onto a web. After deposition of the desired number of layers, the stack of layers is removed from the web, either by dissolving a release layer in a suitable solvent, or by stripping the material from the web. The so-obtained material is then broken down to flakes which have to be further processed by grinding, milling or any suitable method. The resulting product consists of flat flakes with broken edges, irregular shapes and different aspect ratios.

According to one embodiment, the magnetic or magnetizable optically variable pigment particles described herein consist of magnetic cholesteric liquid crystal pigments. Suitable magnetic cholesteric liquid crystal pigments exhibiting optically variable characteristics include without limitation monolayered cholesteric liquid crystal pigments and multilayered cholesteric liquid crystal pigments and are disclosed for example in WO 2006/063926, U.S. Pat. No. 6,582,781 and U.S. Pat. No. 6,531,221. WO 2006/063926 discloses monolayers and pigments obtained therefrom with high brilliance and colorshifting properties with additional particular properties such as magnetizability. The disclosed monolayers and pigments obtained therefrom by comminuting said monolayers comprise a three-dimensionally crosslinked cholesteric liquid crystal mixture and magnetic nanoparticles. U.S. Pat. No. 6,582,781 and U.S. Pat. No. 6,410,130 disclose platelet-shaped cholesteric multilayer pigment which comprise the sequence A¹/B/A², wherein A¹ and A² may be identical or different and each comprises at least one cholesteric layer and B is an interlayer comprising absorption pigments imparting magnetic properties to said interlayer. U.S. Pat. No. 6,531,221 discloses platelet-shaped cholesteric multilayer pigment which comprise the sequence A/B and if desired C, wherein A and C consist of absorbing layer comprising pigment imparting magnetic properties and B is a cholesteric layer.

According to one embodiment, the magnetic or magnetizable optically variable pigment particles described herein consist of interference coated pigments comprising a magnetic material. Suitable interference coated pigments comprising a magnetic material consist of the interference coated pigments described hereabove, wherein the pigment comprise a magnetic material.

Such as disclosed hereafter, the magnetic or magnetizable optically variable pigment particles described herein, in particular the magnetic thin film interference pigments, when incorporated into the optically variable composition may be further oriented after application and before drying or curing, through the application of an appropriate magnetic field and consecutively fixed in their respective positions and orientations by hardening the applied composition.

The coating layer described herein consists of a plurality of optically variable pigment particles present in a binder. As known to those skilled in the art, ingredients comprised in a composition to be applied onto a substrate and the physical properties of said composition are determined by the nature of process used to transfer the composition to the surface of the substrate. Consequently, the binder described herein is typically chosen among those known in the art and depends on the coating or printing process used to apply the composition and the chosen curing process. The term “curing” or “curable” refers to processes including the drying or solidifying, reacting or polymerization of the applied composition in such a manner that it can no longer be removed from the surface onto which it is applied. As mentioned hereafter, the optically variable compositions described herein are applied to a surface by dosing a set amount with a dispensing unit, by pad printing or by screen printing, preferably by pad printing or screen printing and more and preferably by pad printing.

Preferably, the optically variable compositions described herein are selected from the group consisting of radiation curable compositions, thermal drying compositions or any combination thereof.

According to one aspect of the present invention, the optically variable compositions described herein consist of thermal drying compositions. Thermal drying compositions consist of compositions of any type of aqueous compositions or solvent-based compositions which are dried by hot air, infrared or by a combination of hot air and infrared.

Typical examples of thermal drying compositions comprises components including without limitation resins such as polyester resins, polyether resins, vinyl chloride polymers and vinyl chloride based copolymers, nitrocellulose resins, cellulose acetobutyrate or acetopropionate resins, maleic resins, polyamides, polyolefins, polyurethane resins, functionalized polyurethane resins (e.g. carboxylated polyurethane resins), polyurethane alkyd resins, polyurethane-(meth)acrylate resins, urethane-(meth)acrylic resins, styrene(meth)acrylate resins, epoxy resins (e.g. bisphenol A-(epichlorohydrin)) or mixtures thereof. The term “(meth)acrylate” or “(meth)acrylic” in the context of the present invention refers to the acrylate as well as the corresponding methacrylate or refers to the acrylic as well as the corresponding methacrylic.

As used herein, the term “solvent-based compositions” refers to compositions whose liquid medium or carrier substantially consists of one or more organic solvents. Examples of such solvents include without limitation alcohols (such as for example methanol, ethanol, isopropanol, n-propanol, ethoxy propanol, n-butanol, sec-butanol, tert-butanol, iso-butanol, 2-ethylhexyl-alcohol and mixtures thereof); polyols (such as for example glycerol, 1,5-pentanediol, 1,2,6-hexanetriol and mixtures thereof); esters (such as for example ethyl acetate, n-propyl acetate, n-butyl acetate and mixtures thereof); carbonates (such as for example dimethyl carbonate, diethylcarbonate, di-n-butylcarbonate, 1,2-ethylencarbonate, 1,2-propylenecarbonate, 1,3-propylencarbonate and mixtures thereof); aromatic solvents (such as for example toluene, xylene and mixtures thereof); ketones and ketone alcohols (such as for example acetone, methyl ethyl ketone, methyl isobutyl ketone, cyclohexanone, diacetone alcohol and mixtures thereof); amides (such as for example dimethylformamide, dimethyl-acetamide and mixtures thereof); aliphatic or cycloaliphatic hydrocarbons; chlorinated hydrocarbons (such as for example dichloromethane); nitrogen-containing heterocyclic compound (such as for example N-methyl-2-pyrrolidone, 1,3-dimethyl-2-imidazolidone and mixtures thereof); ethers (such as for example diethyl ether, tetrahydrofuran, dioxane and mixtures thereof); alkyl ethers of a polyhydric alcohol (such as for example 2-methoxyethanol, 1-methoxypropan-2-ol and mixtures thereof); alkylene glycols, alkylene thioglycols, polyalkylene glycols or polyalkylene thioglycols (such for example ethylene glycol, polyethylene glycol (such as for example diethylene glycol, triethylene glycol, tetraethylene glycol), propylene glycol, polypropylene glycol (such as for example dipropylene glycol, tripropylene glycol), butylene glycol, thiodiglycol, hexylene glycol and mixtures thereof); nitriles (such as for example acetonitrile, propionitrile and mixtures thereof), and sulfur-containing compounds (such as for example dimethylsulfoxide, sulfolan and mixtures thereof). In addition to the one or more solvents, one or more crosslinking agents may be comprised in the solvent-based compositions.

Typical examples of optically variable compositions comprising a plurality of optically variable pigment particles being thermal drying compositions suitable for the present invention include the followings compositions:

| | | wt-% based on the total |
|---|---|---|
| | | weight of the optically |
| Ingredients | CAS number | variable composition |
| Butylglycol acetate | 112-07-2 | 2-15 |
| 1-methoxy 2-propyl | 108-65-6 | 2-10 |
| acetate | | |
| Epoxy Resin | 25068-38-6 | 20-50 |
| Cyclohexanone | 108-94-1 | 1-5 |
| Solvent Naphta | 64742-94-5 | 1-5 |
| Xylene | 1330-20-7/95-47-6/ | 1-5 |
| | 106-42-3/108-38-3 | |
| Optically variable | | 15-40 |
| pigment particles | | |

Typically, the optically variable compositions described hereabove are hardened in an oven for 5-10 minutes at 90-130° C.

According to one aspect of the present invention, the optically variable compositions described herein consist of radiation curable compositions. Radiation curable compositions consist of compositions that may be cured by UV-visible light radiation (hereafter referred as UV-Vis-curable) or by E-beam radiation (hereafter referred as EB). Radiation curable compositions are known in the art and can be found in standard textbooks such as the series “Chemistry & Technology of UV & EB Formulation for Coatings, Inks & Paints”, published in 7 volumes in 1997-1998 by John Wiley & Sons in association with SITA Technology Limited. According to one embodiment of the present invention, the optically variable compositions described herein consist of UV-Vis-curable optically variable compositions. UV-Vis curing advantageously leads to very fast curing processes and hence drastically decreases the preparation time of cured coating layer for security application. Preferably the binder of the UV-Vis-curable optically variable compositions described herein is prepared from one or more compounds selected from the group consisting of radically curable compounds, cationically curable compounds and mixtures thereof. Cationically curable compounds are cured by cationic mechanisms consisting of the activation by energy of one or more photoinitiators which liberate cationic species, such as acids, which in turn initiate the polymerization so as to form the binder. Radically curable compounds are cured by free radical mechanisms consisting of the activation by energy of one or more photoinitiators which liberate free radicals which in turn initiate the polymerization so as to form the binder. Preferably, the binder of the UV-Vis-curable optically variable compositions described herein is prepared from compounds selected from the group consisting of (meth)acrylates, vinyl ethers, propenyl ethers, cyclic ethers such as epoxides, oxetanes, tetrahydrofuranes, lactones, cyclic thioethers, vinyl and propenyl thioethers, hydroxyl-containing compounds and mixtures thereof. More preferably, the binder of the UV-Vis-curable optically variable compositions described herein is prepared from compounds selected from the group consisting of (meth)acrylates, vinyl ethers, propenyl ethers, cyclic ethers such as epoxides, oxetanes, tetrahydrofuranes, lactones and mixtures thereof.

According to one embodiment of the present invention, the binder of the UV-Vis-curable optically variable compositions described herein is prepared from radically curable compounds selected from (meth)acrylates, preferably selected from the group consisting of epoxy(meth)acrylates, polyester(meth)acrylates, aliphatic or aromatic urethane(meth)acrylates, silicone(meth)acrylates, amino(meth)acrylates, acrylic(meth)acrylates and mixtures thereof. The term “(meth)acrylate” in the context of the present invention refers to the acrylate as well as the corresponding methacrylate. The binder of the UV-Vis-curable optically variable compositions described herein may be prepared with additional vinyl ethers and/or monomeric acrylates such as for example trimethylolpropane triacrylate (TMPTA), pentaerytritol triacrylate (PTA), tripropyleneglycoldiacrylate (TPGDA), dipropyleneglycoldiacrylate (DPGDA), hexanediol diacrylate (HDDA) and their polyethoxylated equivalents such as for example polyethoxylated trimethylolpropane triacrylate, polyethoxylated pentaerythritol triacrylate, polyethoxylated tripropyleneglycol diacrylate, polyethoxylated dipropyleneglycol diacrylate and polyethoxylated hexanediol diacrylate.

According to another embodiment of the present invention, the binder of the UV-Vis-curable optically variable compositions described herein is prepared from cationically curable compounds selected from the group consisting of vinyl ethers, propenyl ethers, cyclic ethers such as epoxides, oxetanes, tetrahydrofuranes, lactones, cyclic thioethers, vinyl and propenyl thioethers, hydroxyl-containing compounds and mixtures thereof, preferably cationically curable compounds selected from the group consisting of vinyl ethers, propenyl ethers, cyclic ethers such as epoxides, oxetanes, tetrahydrofuranes, lactones and mixtures thereof. Typical examples of epoxides include without limitation glycidyl ethers, □-methyl glycidyl ethers of aliphatic or cycloaliphatic diols or polyols, glycidyl ethers of diphenols and polyphenols, glycidyl esters of polyhydric phenols, 1,4-butanediol diglycidyl ethers of phenolformalhedhyde novolak, resorcinol diglycidyl ethers, alkyl glycidyl ethers, glycidyl ethers comprising copolymers of acrylic esters (e.g. styrene-glycidyl methacrylate or methyl methacrylate-glycidyl acrylate), polyfunctional liquid and solid novolak glycidyl ethers resins, polyglycidyl ethers and poly(□□methylglycidyl) ethers, poly(N-glycidyl) compounds, poly(S-glycidyl) compounds, epoxy resins in which the glycidyl groups or □-methyl glycidyl groups are bonded to hetero atoms of different types, glycidyl esters of carboxylic acids and polycarboxylic acids, limonene monoxide, epoxidized soybean oil, bisphenol-A and bisphenol-F epoxy resins. Examples of suitable epoxides are disclosed in EP-B 2 125 713. Suitable examples of aromatic, aliphatic or cycloaliphatic vinyl ethers include without limitation compounds having at least one, preferably at least two, vinyl ether groups in the molecule. Examples of vinyl ethers include without limitation triethylene glycol divinyl ether, 1,4-cyclohexanedimethanol divinyl ether, 4-hydroxybutyl vinyl ether, propenyl ether of propylene carbonate, dodecyl vinyl ether, tert-butyl vinyl ether, tert-amyl vinyl ether, cyclohexyl vinyl ether, 2-ethylhexyl vinyl ether, ethylene glycol monovinyl ether, butanediol monovinyl ether, hexanediol monovinyl ether, 1,4-cyclohexanedimethanol monovinyl ether, diethylene glycol monovinyl ether, ethylene glycol divinyl ether, ethylene glycol butylvinyl ether, butane-1,4-diol divinyl ether, hexanediol divinyl ether, diethylene glycol divinyl ether, triethylene glycol divinyl ether, triethylene glycol methylvinyl ether, tetraethylene glycol divinyl ether, pluriol-E-200 divinyl ether, polytetrahydrofuran divinyl ether-290, trimethylolpropane trivinyl ether, dipropylene glycol divinyl ether, octadecyl vinyl ether, (4-cyclohexyl-methyleneoxyethene)-glutaric acid methyl ester and (4-butoxyethene)-iso-phthalic acid ester. Examples of hydroxy-containing compounds include without limitation polyester polyols such as for example polycaprolactones or polyester adipate polyols, glycols and polyether polyols, castor oil, hydroxy-functional vinyl and acrylic resins, cellulose esters, such as cellulose acetate butyrate, and phenoxy resins. Further examples of suitable cationically curable compounds are disclosed in EP-B 2 125 713 and EP-B 0 119 425.

UV-Vis curing of a monomer, oligomer or prepolymer may require the presence of one or more photoinitiators and may be performed in a number of ways. As known by those skilled in the art, the one or more photoinitiators are selected according to their absorption spectra and are selected to fit with the emission spectra of the radiation source. Depending on the monomers, oligomers or prepolymers used to prepare the binder comprised in the UV-Vis-curable optically variable compositions described herein, different photoinitiators might be used. Suitable examples of free radical photoinitiators are known to those skilled in the art and include without limitation acetophenones, benzophenones, alpha-aminoketones, alpha-hydroxyketones, phosphine oxides and phosphine oxide derivatives and benzyldimethyl ketals. Suitable examples of cationic photoinitiators are known to those skilled in the art and include without limitation onium salts such as organic iodonium salts (e.g. diaryl iodoinium salts), oxonium (e.g. triaryloxonium salts) and sulfonium salts (e.g. triarylsulphonium salts). Other examples of useful photoinitiators can be found in standard textbooks such as “Chemistry & Technology of UV & EB Formulation for Coatings, Inks & Paints”, Volume III, “Photoinitiators for Free Radical Cationic and Anionic Polymerization”, 2nd edition, by J. V. Crivello & K. Dietliker, edited by G. Bradley and published in 1998 by John Wiley & Sons in association with SITA Technology Limited. It may also be advantageous to include a sensitizer in conjunction with the one or more photoinitiators in order to achieve efficient curing. Typical examples of suitable photosensitizers include without limitation isopropyl-thioxanthone (ITX), 1-chloro-2-propoxy-thioxanthone (CPTX), 2-chloro-thioxanthone (CTX) and 2,4-diethyl-thioxanthone (DETX) and mixtures thereof. The one or more photoinitiators comprised in the UV-Vis-curable optically variable compositions are preferably present in an amount from about 0.1 to about 20 weight percent, more preferably about 1 to about 15 weight percent, the weight percents being based on the total weight of the UV-Vis-curable optically variable compositions.

Alternatively, the binder of the UV-Vis-curable optically variable compositions described herein is a hybrid binder and may be prepared from a mixture comprising radically curable compounds and cationically curable compounds such as those described herein as well as their respective photoinitiators described herein.

Alternatively, dual-cure compositions may be used; these compositions combine thermal drying and radiation curing mechanisms. Typically, such compositions are similar to radiation curing compositions such as those described herein but include a volatile part constituted by water or by solvent. These volatile constituents are evaporated first using hot air or IR driers, and UV drying is then completing the hardening process.

The optically variable compositions described herein may further comprise one or more machine readable materials. When present, the one or more machine readable materials are preferably selected from the group consisting of magnetic materials, luminescent materials, electrically conductive materials, infrared-absorbing materials and mixtures thereof. As used herein, the term “machine readable material” refers to a material which exhibits at least one distinctive property which is not perceptible by the naked eye, and which can be comprised in a layer so as to confer a way to authenticate said layer or article comprising said layer by the use of a particular equipment for its detection and/or authentication.

The optically variable compositions described herein may further comprise one or more additives including without limitation compounds and materials which are used for adjusting physical, rheological and chemical parameters of the composition such as the viscosity (e.g. solvents and surfactants), the consistency (e.g. anti-settling agents, fillers and plasticizers), the foaming properties (e.g. antifoaming agents), the lubricating properties (waxes), UV stability (photostabilizers) and adhesion properties, etc. Additives described herein may be present in the optically variable compositions described herein in amounts and in forms known in the art, including in the form of so-called nano-materials where at least one of the dimensions of the particles is in the range of 1 to 1000 nm.

The optically variable compositions described herein may be prepared by dispersing or mixing the plurality of optically variable pigment particles described herein, and the one or more additives when present in the presence of binder or binder precursors described herein, thus forming liquid or pasty inks. When present, the one or more photoinitiators may be added to the composition either during the dispersing or mixing step of all other ingredients or may be added at a later stage, i.e. after the formation of the liquid or pasty inks.

With the aim of increasing the wear and soil resistance or with the aim of modifying the optical gloss or aesthetic appearance of the security element and the embossed metal coin, the embossed metal coin according to the present invention may further may further comprise one or more protective layers at least partially or fully overlapping the optically variable layer. When present, the one or more protective layers are typically made of protective varnishes which may be transparent or slightly colored or tinted and may be more or less glossy. Protective varnishes may be radiation curable compositions, thermal drying compositions or any combination thereof such as those described hereabove. Preferably, the one or more protective layers are made of radiation curable, more preferably UV-Vis curable compositions.

The embossed metal coin according to the present invention may further comprise one or more layers selected from the group consisting of primers, adhesive layers, decorative layers, functional layers and combinations thereof, wherein said one or more layers are at least present below the coating layer. The one or more layers described herein may be transparent or opaque and/or may be colored or tinted. The one or more layers may provide additional functionality such as for example machine readable properties through specific absorption of light or electromagnetic radiation, luminescence, magnetic properties or other detectable properties. The one or more layers described herein may be color constant layers having a color matching the color impression of the optically variable composition comprising a plurality of optically variable pigment particles at one viewing angle.

Described herein are also processes to prepare embossed metal coins and embossed metal coins obtained therefrom, the process according to the present invention comprises the steps of:

a) applying by dosing a set amount with a dispensing unit, by pad printing or by screen printing, preferably by pad printing or screen printing and more preferably by pad printing, the optically variable composition described herein on an embossed metal coin; and

b) hardening the optically variable composition so as to form a coating layer on the embossed metal coin.

As discussed herein, depending on the ingredients comprised in the optically variable composition, especially the binder, the hardening step may be done by radiation curing, in particular UV-Vis curing, thermal drying or by any combination thereof.

When at least a part of the plurality of optically variable pigment particles described consists of magnetic or magnetizable optically variable pigment particles described herein, the process according to the present invention preferably comprises the steps of
a) applying by dosing a set amount with a dispensing unit, by pad printing or by screen printing, preferably by pad printing or screen printing and more preferably by pad printing, the optically variable composition described herein on an embossed metal coin;
b) exposing the optically variable composition to a magnetic field hereby orienting the magnetic or magnetizable optically variable pigment particles; and
c) hardening the optically variable composition so as to form a coating layer on the embossed metal coin.

The step of exposing the optically variable composition to a magnetic field (step b)) can be performed either simultaneously with the step a) or subsequently to the step a).

During the step of exposing the optically variable composition applied to the embossed metal coin to a magnetic field hereby orienting the magnetic or magnetizable optically variable pigment particles within the binder (step b)), the optically variable composition is still wet or soft enough that the magnetic or magnetizable optically variable pigment particles described herein can be moved and oriented. The step of magnetically orienting the magnetic or magnetizable optically variable pigment particles consists of a step of exposing the applied composition, while it is “wet”, to an appropriate and determined magnetic field generated at a surface of a magnetic-field-generating device, thereby orienting the pigments along field lines of the magnetic field, i.e. a step of bringing the optically variable composition sufficiently close or in contact with the magnetic-field-generating device. This approaching or bringing close together allows the magnetic or magnetizable optically variable pigment particles in the composition to be oriented with respect to the magnetic field. The magnetic field may be applied either i) from the side of the embossed metal coin which carries the optically variable composition, or ii) from the side of the metal embossed coin opposite to the optically variable composition, or iii) from one or several directions that differ from the normal to the surface of the metal embossed coin carrying the optically variable composition. Here, applying the magnetic field from a specified side or direction means that the device that generates the magnetic field is physically located at a specified distance from the embossed metal coin along said direction or on said side of the embossed metal coin. The magnetic field generating device may be a permanent magnet, as set of permanent magnet and/or pole pieces, or solenoids and/or pole pieces. Noteworthy, the optically variable composition applied on the embossed metal coin may practically be brought into contact with the magnetic device. Alternatively, an air gap, or an intermediate separating layer may be provided. By appropriately shaping the field lines of the magnetic field, the magnetic or magnetizable optically variable pigment particles can be oriented in a pattern producing a corresponding magnetically induced image or pattern which can be very difficult, if not impossible to reproduce or counterfeit without an appropriate, not widely available, material. The orientation and position of the magnetic or magnetizable optically variable pigment particles within the binder is then permanently fixed or frozen by the hardening step c). Materials and technology for the orientation of magnetic particles in a coating composition, and corresponding combined printing/magnetic orienting processes have been disclosed in U.S. Pat. No. 2,418,479; U.S. Pat. No. 2,570,856; U.S. Pat. No. 3,791,864; DE-A 2006848; U.S. Pat. No. 3,676,273; U.S. Pat. No. 5,364,689; U.S. Pat. No. 6,103,361; US 2004/0051297; US 2004/0009309; EP-A 0 710 508, WO 02/090002; WO 03/000801; WO 2005/002866, and US 2002/0160194. The magnetic-field-generating device may comprise a magnetic plate which may furthermore carry surface relief, engravings or cut-outs. For example, Intl Pat. App. Pub. No WO 2005/002866 and WO 2008/046702 disclose examples of engraved magnetic plates. When the step of exposing the optically variable composition to the magnetic field (step b)) is simultaneously performed with the step of applying the composition by pad printing or screen printing (step a)), the magnetic device used for orienting the magnetic or magnetizable optically variable pigment particles (step b)) may be movable, suitable examples of movable magnetic orienting units are disclosed in WO 2010/066838.

When a pad printing process is used, the magnetic device used for orienting the magnetic or magnetizable optically variable pigment particles within the binder may be present in the pad of the printing assembly.

The hardening step (step c)) can be performed either simultaneously with the step of exposing the optically variable composition to a magnetic field (step b)) or subsequently to the step b).

The embossed metal coin described herein is maintained in place during the applying step (step a)), the optional exposing step (step b)) and hardening step (step c)) by any conventional supporting means.

Also described herein are uses of the coating layer described herein for the protection of an embossed metal coin against fraud or illegal reproduction.

Also described herein are methods for protecting an embossed metal coin against fraud or illegal reproduction, said methods comprising the step of:
a) applying by dosing a set amount with a dispensing unit, by pad printing or by screen printing, preferably by pad printing or screen printing and more preferably by pad printing, the optically variable composition described herein on an embossed metal coin, and
b) hardening, preferably by a process selected from the group consisting of radiation-curing, in particular UV-Vis curing, thermal drying and combinations thereof, the optically variable composition so as to form a coating layer on the embossed metal coin.

As mentioned hereabove, when at least a part of the plurality of optically variable pigment particles described consists of magnetic or magnetizable optically variable pigment particles described herein, the method according to the present invention preferably comprises a step of exposing the optically variable composition to a magnetic field hereby orienting the magnetic or magnetizable optically variable pigment particles within the binder, said step of exposing the optically variable composition to a magnetic field can be performed either simultaneously with the step of applying the optically variable composition (step a)) to or subsequently to the step a)). The magnetic or magnetizable optically variable pigment particles described herein may be oriented such as described hereabove.

Alternatively, embossed metal coins may be prepared with the steps consisting of applying by dosing a set amount with a dispensing unit, by pad printing or by screen printing, preferably by pad printing or screen printing and more preferably by pad printing, the optically variable composition described herein on a non-embossed metal coin; optionally exposing the optically variable composition to a magnetic field; and hardening the optically variable composition and a further step of embossing said metal coin comprising a coating layer made of the optically variable composition.

Screen printing (also referred in the art as silkscreen printing) is a stencil process whereby an ink is transferred to a surface through a stencil supported by a fine fabric mesh of silk, synthetic fibers or metal threads stretched tightly on a frame. The pores of the mesh are block-up in the non-image areas and left open in the image area, the image carrier being called the screen. Screen printing might be flat-bed or rotary. During printing, the frame is supplied with the ink which is flooded over the screen and a squeegee is then drawn across it, thus forcing the ink through the open pores of the screen. At the same time, the surface to be printed is held in contact with the screen and the ink is transferred to it. Screen printing is further described for example in The Printing ink manual, R. H. Leach and R. J. Pierce, Springer Edition, 5^{th} Edition, pages 58-62 and in Printing Technology, J. M. Adams and P. A. Dolin, Delmar Thomson Learning, 5^{th} Edition, pages 293-328.

Pad printing is an indirect gravure process (also referred in the art as indirect offset process) employing an etched printing plate (also referred in the art as cliché plate). While the printing plate does not come in direct contact with the surface to be printed, the image is transferred onto the surface to be printed by means of a pad. The pad printing process usually consists of three elements: the printing plate, the printing material and the pad. The printing plate comprises the image of interest which has been chemically or photo etched, said printing plates being usually made from metals like steel, photopolymers and/or ceramics. The printing plate is flooded or coated with the printing material and then the printing material excess is removed from the plate thus leaving a deposit of printing material in the etched area only. The printing material is transferred from the etching of the printing plate to a pad, in general a soft silicone pad, and said pad is then pressed onto the surface to be printed so as to transfer the printing material from the pad to the surface to be printed. Whereas many machine designs exist, there are mainly two basic configurations: the open inkwell design and the closed or sealed ink cup system. An open inkwell machine uses a spatula to flood the printing plate and a doctor blade assembly to scrape off the excess of printing material without removing printing material from the etched image area. A closed or sealed ink cup machine uses an inverted cup comprising the printing material. Unlike the open inkwell machine, the closed or sealed ink cup does not require a spatula since the inverted cup is directly placed onto the etched image. The rim of the cup contains a hardened metal ring that removes the printing material outside the etched image area. Typically, suitable inks for pad printing have a viscosity in the range from about 0.8 to about 5 Pas as measured on Viscosimeter RV1 from Thermo Scientific as described in the Examples Part.

### Examples

The present invention is now described in greater detail with respect to non-limiting examples.

TABLE 1

| | Optically variable | |
|---|---|---|
| Ingredients | composition | |
| Butylglycol acetate (CAS 112-07-2) | 13 | wt-% |
| 1-methoxy 2-propyl acetate (CAS 108-65-6) | 7 | wt-% |
| Epoxy Resin (CAS 25068-38-6) | 39 | wt-% |
| Cyclohexanone (CAS 108-94-1) | 2 | wt-% |
| Solvent Naphta (CAS 64742-94-5) | 2 | wt-% |
| Xylene (CAS 1330-20-7/95-47-6/ | 2 | wt-% |
| 106-42-3/108-38-3) | | |
| optically variable pigment particles with a | 35 | wt-% |
| colorshift red/gold (OVP ®, thin film | | |
| interference pigments, from JDS UNIPHASE | | |
| CORPORATION, Milpitas CA USA) | | |
| Viscosity at 25° C./ | 2.8 | Pa s |

100 g of the optically variable composition were prepared by mixing the ingredients described in Table 1. Mixing was done at room temperature with a dispersing propeller (stainless steel 4.0 cm diameter) at a speed of 1000 rpm for a period of ten minutes.

The viscosity of the optically variable composition of Table 1 was measured on a Viscosimeter RV1 from Thermo Scientific. A small quantity of ink was applied on the plate of the instrument and viscosity was measured at 25° C. according to the measurement method of the viscometer under the following conditions: a) cone-plate system with a truncated cone of 2 cm diameter, 0.5° angle and 25 μm truncation, and b) scanning speed: 0-1000 s⁻¹ in 30 sec.

The optically variable composition was applied to an embossed metal coin (5 CHF metal coin) with a pad-printing machine supplied by Wittich with the following characteristics:
a) pad printing press: sealed ink cup 60E,
b) cliché plate: High Tech Ceramik 140×70, engraving depth: 18 microns, and no raster-Dots/Screening: none (full engraving)
c) Pad: Silicon-Material: Q3, Hardness: 6 Shore A, Shape No. 373

The optically variable composition was then hardened in an oven at a temperature of about 110° C. for about ten minutes.

1. An embossed metal coin comprising a coating layer made of an optically variable composition comprising a plurality of optically variable pigment particles.

2. The embossed metal coin according to claim 1, wherein at least a part of the plurality of optically variable pigment particles consists of thin film interference pigments, interference coated pigments, cholesteric liquid crystal pigments or mixtures thereof.

3. The embossed metal coin according to claim 1, wherein at least a part of the plurality of optically variable pigment particles consists of magnetic or magnetizable optically variable pigment particles.

4. The embossed metal coin according to claim 3, wherein the magnetic or magnetizable optically variable pigment particles are selected from the group consisting of magnetic thin-film interference pigments, magnetic cholesteric liquid crystal pigments, interference coated pigments comprising a magnetic material and mixtures thereof.

5. The embossed metal coin according to claim 4, wherein the magnetic thin-film interference pigments comprise 5-layer Fabry-Perot absorber/dielectric/reflector/dielectric/absorber multilayer structures wherein the reflector and/or the absorber is a magnetic layer.

6. The embossed metal coin according to claim 4, wherein the magnetic thin-film interference pigments comprise 7-layer Fabry-Perot absorber/dielectric/reflector/magnetic/reflector/dielectric/absorber multilayer structures.

7. The embossed metal coin according to claim 5, wherein the reflector layers are independently selected from the group consisting of aluminum (Al), chromium (Cr), nickel (Ni), and mixtures thereof; and/or the dielectric layers are independently selected from the group consisting of magnesium fluoride (MgF₂), silicium dioxide (SiO₂) and mixtures thereof; and/or the absorber layers are selected from the group consisting of chromium, nickel, metal alloys and mixtures thereof and/or the magnetic layer is selected from the group consisting of nickel (Ni), iron (Fe) and cobalt (Co) and mixtures and/or alloys thereof.

8. The embossed metal coin according to claim 6, wherein the 7-layer Fabry-Perot absorber/dielectric/reflector/magnetic/reflector/dielectric/absorber layers are multilayer structures of Cr/MgF₂/Al/Ni/Al/MgF₂/Cr.

9. The embossed metal coin according to claim 1, wherein the optically variable composition further comprises a machine readable material selected from the group consisting of magnetic materials, luminescent materials, electrically conductive materials, infrared-absorbing materials and mixtures thereof.

10. The embossed metal coin according to claim 1, wherein the optically variable composition is selected from the group consisting of radiation curable compositions, thermal drying compositions and combinations thereof.

11. The embossed metal coin according to claim 1 further comprising one or more protective layers at least partially or fully overlapping the optically variable layer.

12. The embossed metal coin according to claim 1 further comprising one or more layers selected from the group consisting of primers, adhesive layers, decorative layers, functional layers and combinations thereof, wherein said one or more layers are at least present below the coating layer.

13. The embossed metal coin according to claim 12, wherein the one or more layers are color constant layers having a color matching the color impression of the optically variable composition comprising a plurality of optically variable pigment particles at one viewing angle.

14. A process for preparing the embossed metal coin recited in claim 1, comprising the step of:
a) applying by dosing a set amount with a dispensing unit, by pad printing or by screen printing the optically variable composition on an embossed metal coin; and
b) hardening the optically variable composition so as to form a coating layer on the embossed metal coin.

15. The process according to claim 14, wherein the optically variable composition comprise at least a part of the plurality of optically variable pigment particles consisting of magnetic or magnetizable optically variable pigment particles, said process comprising the step of:
a) applying by dosing a set amount with a dispensing unit, by pad printing or by screen printing the optically variable composition on an embossed metal coin;
b) exposing the optically variable composition to a magnetic field hereby orienting the magnetic or magnetizable optically variable pigment particles; and
c) hardening the optically variable composition so as to form a coating layer on the embossed metal coin.

16. The process according to claim 14, wherein step a) is done by pad printing.

17. A use of the coating layer recited in claim 1 for the protection of an embossed metal coin against fraud or illegal reproduction.

18. A method for protecting an embossed metal coin against fraud or illegal reproduction comprising the steps of:
a) applying by dosing a set amount with a dispensing unit, by pad printing or screen printing the optically variable composition recited in claim 1 on an embossed metal coin; and
b) hardening the optically variable composition so as to form a coating layer on the embossed metal coin.

19. The method according to claim 18, wherein the optically variable composition comprise at least a part of the plurality of optically variable pigment particles consisting of magnetic or magnetizable optically variable pigment particles, said process comprising the steps of:
a) applying by dosing a set amount with a dispensing unit, by pad printing or by screen printing the optically variable composition on an embossed metal coin;
b) exposing the optically variable composition to a magnetic field hereby orienting the magnetic or magnetizable optically variable pigment particles; and
c) hardening the optically variable composition so as to form a coating layer on the embossed metal coin.
